(19) United States
(12) Patent Application Publication
(10) Pub. No.: US 2002/0132353 A1
(43) Pub. Date: Sep. 19, 2002

(54) Turntable type liquid reagent stirring apparatus and turntable type liquid reagent stirring/fractionally pouring apparatus using said stirring apparatus

(76) Inventors: Tomoaki Tamura, Hino City (JP); Takayuki Mizutani, Mishima City (JP)

Correspondence Address: Scully, Scott, Murphy & Presser, 400 Garden City Plaza, Garden City, NY, 11530, US

(21) Appl. No.: 10/029,631

(22) Filed: Dec. 21, 2001

(30) Foreign Application Priority Data
Dec. 27, 2000 (JP) 2000-396685

(51) Int. Cl. G01N 35/00; G01N 35/02

(52) U.S. Cl. 436/43; 436/45; 422/63; 422/64

(57) ABSTRACT

A turntable type liquid reagent-mixing device to be used in an automatically analyzing apparatus for the detection of a substance to be measured with using a liquid reagent containing fine particles, including (1) a turntable adapted for placing thereon a plurality of containers which contain liquid reagent to be mixed, (2) a turntable rotating mechanism adapted for rotating said turntable to rotate the containers around a rotary center of the turntable, and (3) a container-rotating mechanism for rotating the containers themselves around their own respective rotary centers at their respectively placed locations on the turntable, wherein while the containers are rotated around the rotary center of the turntable, and the containers themselves are rotated around their own respective rotary centers at places where the containers are placed, thereby uniformly dispersing the fine particles contained in the liquid reagent.

### BACKGROUND OF THE INVENTION

### Technical Field of the Invention

The present invention relates to turntable type liquid reagent-mixing devices to be favorably used in automatic analyzers, which automatically analyze the detection of substances to be measured, by using liquid reagents contained fine particles. The invention also relates to, turntable type liquid reagent sampling/dispensing apparatuses using said mixing devices. The invention is to effectively mix the liquid reagent and uniformly disperse the fine particles contained therein before the liquid reagent is dispensed. The liquid medium is fundamentally composed of the fine particles and a suspension medium suspending said fine particles.

In the immune analyses, etc. effected based on antigen/antibody reactions, a liquid reagent containing fine particles on which an antigen or an antibody is carried is used. As the analysis method using such a liquid reagent, a agglutination assay using blood cells, a latex turbdimetric immunoassay, an immunoassay method using magnetic particles, etc. are known.

As the liquid reagents used in the above analyses methods, blood cell reagents, latex reagents, magnetic particle solid phase carriers, etc. are specifically recited. When such a liquid is to be dispensed, the fine particles contained in the liquid reagent need to be so dispersed by sufficiently mixing the liquid reagent in any method that the concentration may be made uniform.

Uniform dispersion of fine particles is heretofore accomplished by the following methods: the liquid reagent is mixing by placing a mixing element in a liquid reagent container and moving the mixing element in the liquid reagent inside the container, or alternatively by directly acting a mixing means such as a mix bar upon the liquid reagent in the container. As to the prior art regarding this, reference is made to JP4-296654, JP2000-46836, etc.

However, the conventional mixing systems using the mixing element or the mixing means have the following problems.

Since mixing with the mixing element requires a driving mechanism and control unit, it is inevitable that the structure of the device is complicated and the cost for the function increases. Further, mixing can be incomplete because of mixing element driving fault.

On the other hand, it is also inevitable in case of mixing with the mixing means that the structure of the apparatus is complicated and the cost for the apparatus increases as in the case of mixing with the mixing element. In addition, since the mixing element must be immersed in the liquid reagent, a so-called contamination phenomenon that different solutions are mixed between the reagents cannot be happened in the case of random access analyzer.

In any of the conventional methods, the mixing element or the mixing means is brought into a direct contact with the reagent, it is feared that the quality of the reagent is deteriorated (e.g. reduction in activity of a binding material or particle separation or homolysis).

As a means for solving the problems in using the mixing element or the mixing means and realizing the sufficiently mixing effect, eccentric mixing is known in which a upper portion of the reagent container is fixedly held, and the container is turned in the state that a lower portion of the container is kept eccentric. JP-B 6-63945, JP-UT-B 7-25217, JP-A 11-38,009, etc.

Further, a method is proposed in which a pipe is inserted into a reagent container, and the liquid is oscillated by repeatedly pressurizing and depressurizing the liquid through the pipe (JP-A 8-201396). With respect to this method, in addition to the above mixing means, reference is also made to a technique that the reagent container is transferred in a strongly mixing/dispersing unit where mixing and dispersing operation is separately carried.

[Problems to be Solved by the Invention]

However, these methods need to use many members newly prepared to practice the mixing operation, such as means for inducing eccentric mixing, the pipe and pump, means for transferring vessels, etc. Thus, the methods still suffer from the problems that the derives are complicated and the cost rise cannot be suppressed.

It is an object of the present invention to provide a novel turntable type liquid reagent-mixing device and a turntable type liquid reagent sampling-dispensing apparatus using said device. The mixing device can uniformly disperse fine particles contained in the liquid reagent and be favorably used in an automatic analyzer for automatically analyzing the detection of a substance to be measured with use of the liquid reagent containing the fine particles.

[Countermeasures for Solving the Problems]

A first aspect of the present invention relates to a turntable type liquid reagent-mixing device to be used in an automatically analyzing apparatus for the detection of a substance to be measured with using a liquid reagent containing fine particles, said mixing device comprising:

(1) a turntable to set some containers which contain a liquid reagent to be mixed;

(2) a turntable rotating mechanism adapted for rotating said turntable to rotate said containers around a rotary center of the turntable; and

(3) a container-rotating mechanism for rotating the containers themselves around their own respective rotary centers at their respectively placed locations on the turntable.

According to the turntable type liquid reagent-mixing device of the present invention, the containers are rotated around the rotary center of the turntable, while the containers themselves are rotated around their own respective rotary centers at their respectively placed locations. Thereby, the reagent is mixed by an interaction between centrifugal forces (centripetal forces) generated at that time and friction forces generated between wall faces of the containers and the reagent, so that the fine particles contained in the reagent are uniformly dispersed. As the container, a container having a cylindrical peripheral wall for receiving the liquid sample may be used, for example.

In the following, preferred embodiments of the present invention will be listed. Any combination of the following may be preferred embodiments, unless any particular contradiction exists.

(1) The container-rotating mechanism is driven by the turntable-rotating mechanism, and thereby the containers are rotated around their own respective rotary centers at their respective placed locations on the turntable. In an embodiment of the present invention, the turntable-rotating mechanism and the container-rotating mechanism can be independently driven. The construction of the mixing device can be more simplified, and the system can be driven by one actuator. When the turntable-rotating mechanism around each center of the containers is constituted by a motor and a turntable rotary shaft to be driven by the actuator, the motor rotates the turntable rotary shaft, which rotates the turntable to drive the container-rotating mechanism and rotate the containers around their own respective rotary centers.

(2) The turntable-rotating mechanism is constituted by a motor and a turntable rotation power-transmitting portion to be rotated by the motor; the container-rotating mechanism is rotated by the turntable rotation power-transmitting portion, and thereby the containers are rotated around their respective rotary centers at their respectively placed locations on the turntable. The driving shaft of the motor may be coaxial with a driven shaft of the turntable rotation power-transmitting portion. Alternatively, the driving shaft of the motor may be meshed with an outer periphery of the turntable rotation power-transmitting portion.

(3) The turntable-rotating mechanism comprises a first gear, the container-rotating mechanism comprises secondary gears for the respective containers, and the secondary gears mesh with the first one. The first gear may mesh with the secondary gears directly or via other gears. In the case of the direct meshing, the rotating direction of the turntable is reverse to that of the containers. When the first gear meshes with the secondary gear via one gear, the first and secondary gears can be rotated in the same direction.

(4) The teeth portion of the secondary gear meshes with an outer peripheral teeth portion of the first one. The meshing structure between the first and secondary gears is simplified.

(5) A third annular gear is arranged around the outer periphery of the secondary gears, the secondary gears mesh with an inner peripheral gear portion of the third gear. By changing the number of teeth of the inner peripheral teeth portion of the third annular gear, the number of rotations of the container around its own rotary center per one rotation of the container around the rotary center of the turntable can be changed.

(6) The container rotates around its own rotary center by integer times as much as one rotation of the container around the rotary center of the turntable. The direction of the reagent container can be determined one-by-one even if the turntable stops one of the predetermined location corresponding to the analyte.

(7) The container-rotating mechanism comprises container-placing adaptors to holding the respective containers, and the containers are rotated around their own respective rotary axes by rotating the container-placing adaptors. The construction for rotating the containers may be a mechanism for rotating the containers around their own respective rotary centers. By using the above container-placing adaptors, the containers can be stably placed and rotated around their own respective rotary center.

(8) Means of preventing the containers from running idle is provided for the container by the container-placing adaptor. No limitation is posed upon the means of preventing the containers from running idle , so long as no rotary deviation occurs between the container and the container-placing adaptor. By using the means of preventing the container from running idle, the positional relationship between the container and the container-placing adaptor, in turn the container-rotating mechanism is kept uniquely, so that the number of rotations of the container around its own rotary center can be controlled with respect to the rotation of the container around the rotary center of the turntable.

(9) The containers are concentrically placed around the rotary axis of the turntable. The liquid sample can be effectively mixed, and liquid samples can be efficiently aspirated and dispensed.

(10) The containers are concentrically placed around the rotary axis of the turntable concentrically along double or more lines. Although the containers along the respective lines may be rotated by respectively separated container-rotating mechanisms, the containers along one line may be rotated around their own respective rotary centers by the rotation of the containers around their own respective rotary centers along a different line.

(11) A code reader is provided to read codes for the liquid reagents to be mixed which codes are attached to the containers receiving the liquid reagents. As the reader, a bar coder or the like may be used. By the reader, the liquid samples sampled and dispensed from the liquid reagents after being mixed can be correctly corresponded with analysis results.

A second aspect of the present invention relates to a turntable type liquid reagent mixing/dispensing apparatus to be used in an automatic analyzer for detecting a substance to be measured with a liquid reagent containing fine particles, said liquid reagent mixing/dispensing apparatus comprising the turntable type liquid reagent-mixing device according to the first aspect of the invention and a dispensing device.

The turntable type liquid reagent-mixing device comprises:

(1) a turntable to set a plurality of containers which contain liquid reagent to be mixed;

(2) a turntable rotating mechanism adapted for rotating said turntable to rotate said containers around a rotary center of the turntable; and

(3) a container-rotating mechanism for rotating the containers themselves around their own respective rotary centers at their respectively placed locations on the turntable.

The dispensing device is adapted to successively aspirate and dispense the mixed liquid reagent, at a given location, from the containers receiving the mixed solutions which containers are placed on the turntable.

The preferred embodiments of the turntable type liquid reagent-mixing device according to the first aspect of the present invention are also preferred embodiments according to the turntable type liquid reagent mixing-dispensing apparatus of the second aspect of the present invention.

A third aspect of the present invention relates to an automatic analyzer comprising the turntable type liquid reagent mixing/dispensing apparatus according to the second aspect of the present invention, a reactor for mixing and reacting a liquid to be examined, such as blood or urine, with the liquid reagent dispensed from the mixing-dispensing apparatus, and a detector for reading a reaction result of a reaction product obtained by the reaction.

The preferred embodiments of the turntable type liquid reagent-mixing device according to the first aspect of the present invention are preferred embodiments of the third aspect of the present invention.

### BRIEF DESCRIPTION OF THE DRAWINGS

FIG. 1 is a sectional view of showing a construction of the mixing device according to the present invention to be arranged in an automatic analysis apparatus.

FIG. 2 is a sectional view of showing another construction of the mixing device according to the present invention to be arranged in the automatic analysis apparatus.

FIG. 3 is a plane view of FIG. 2.

FIG. 4 is a plane view of a turn table.

FIG. 5 is a figure showing a principal portion of a rotating mechanism.

FIG. 6 is a figure showing a principal portion of a rotating mechanism.

FIG. 7 is a figure showing a principal portion of a rotating mechanism.

FIG. 8 is a figure showing an outer appearance of favorable adaptor and container in the present invention.

FIG. 9 is a figure showing an outer appearance of a container into which a reagent is to be sealed.

FIG. 10 is a figure illustrating a way of dispensing.

FIG. 11 is a figure illustrating a way of dispensing.

FIG. 12 is a figure showing a further construction of the mixing device.

FIG. 13 is a figure showing other construction of the mixing device.

FIG. 14 is a figure showing a time chart in mixing.

FIG. 15 is a graph showing the relationship between the number of analyses and the fluctuation in the concentration of particles.

FIG. 16 is a graph showing the relationship between the number of rotations around own rotary center (number of rotations of turntable) and the fluctuation in the concentration of particles.

### BEST MODE FOR CARRYING OUT THE INVENTION

The present invention will be explained below more concretely by referring to the drawings.

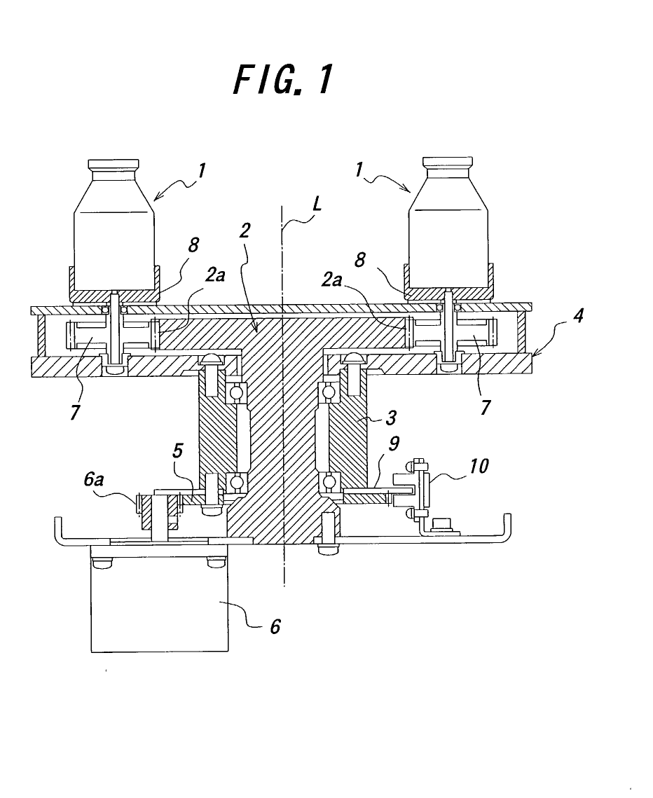

FIG. 1 is a sectional view of a turntable type liquid reagent-mixing device according to the present invention to be favorably used in an automatic analysis apparatus which is adapted to automatically analyze a target material with use of the liquid reagent fine particles.

In FIG. 1, a reference numeral 1 denotes a cylindrical container for receiving the liquid reagent containing fine particles. A reference numeral 2 denotes a base member maintaining an erected posture. A gear 2a is provided at an upper end of the base member 2.

A reference numeral 3 denotes a cylindrical body rotatably held to the base member via bearings, and a turntable 4 is connected to an upper end of the cylindrical body 3 such that the gear 2a of the base member 2 is vertically sandwiched therein. A reference numeral 5 is a gear connected to an lower end of the cylindrical body 3.

A reference numeral 6 denotes a driving source such as a motor, which driving source is connected to the gear 5 via a gear 6a arranged at a tip of the driving source.

A reference numeral 7 denotes a rotary center-rotating gear meshing with the gear 2a of the base member 2 held rotatably in the turntable 4, 8 an adaptor connected to a rotary shaft of the rotary center-rotating gear 7 above the turn table 4, 9 a sensor plate, and 10 a location-detecting sensor.

The containers are placed on their respective adaptors 8 when mixing the reagent. As the driving source 6 is operated, its rotating power is transmitted to the cylindrical body 3 via the gears 6a and 5, thereby rotating the cylindrical body 3 around the base member 2.

Accordingly, the turntable 4 connected to the cylindrical body 3 is rotated around the shaft axis L of the base member 2, so that the containers 1 rotate around the shaft axis L.

The gears 7 held in the turntable 4 mesh with the gears 2a of the base member 2. As the turntable 4 rotates, the gears 7 are rotated to rotate the adaptors 8 themselves attached to the ends of shafts of the gears 7 in synchronization with the rotation of the gears 7. Thereby, the containers 1 rotate around their own respective rotary centers, while the containers rotate around the rotary axis L. The reagent in the container 1 is mixed owing to the frictional forces between the reagent and the wall surface of the container under the action of the centrifugal force (centripetal force) resulting from the rotation around the rotary axis L, so that the fine particles contained in the reagent are uniformly dispersed. At that time, the direction of the rotation of the turntable 4 is reverse to that of the adaptor 8.

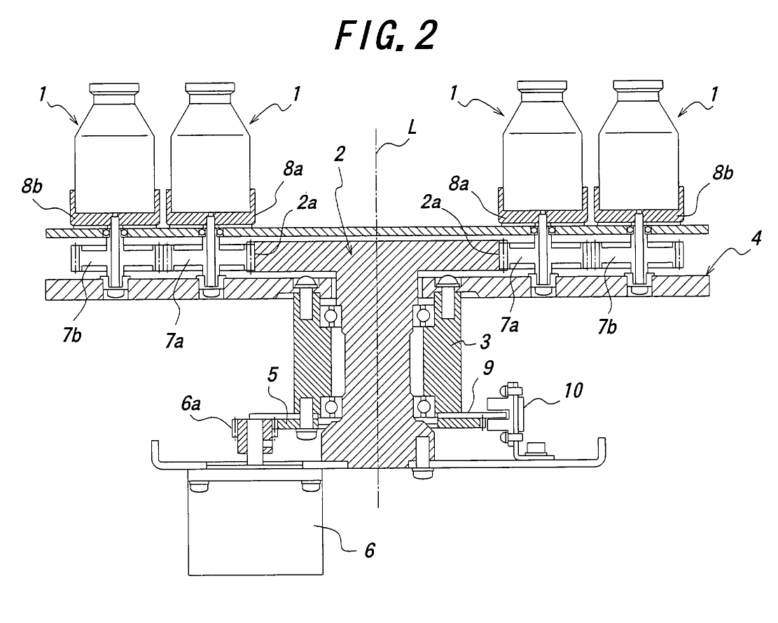

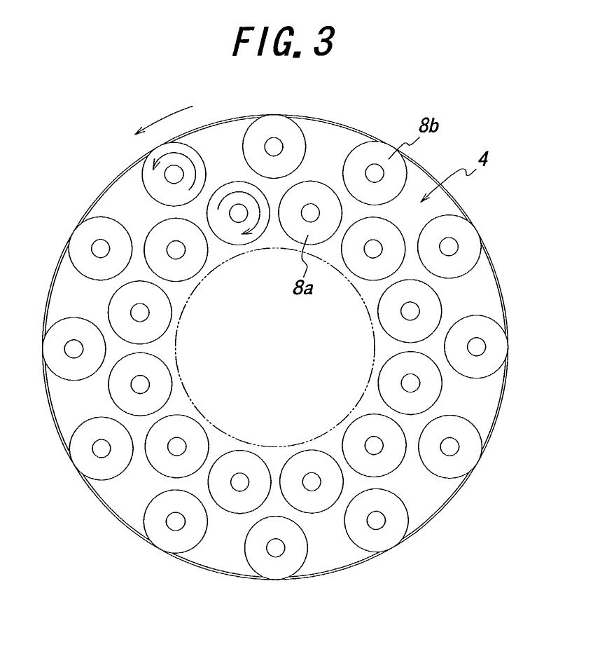

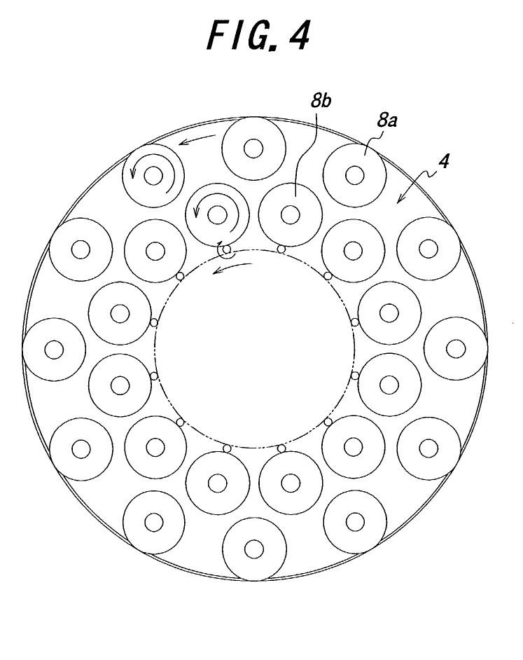

FIGS. 2 and 3 show sectional and plane views of another embodiment of the turntable type liquid reagent-mixing device according to the present invention. In above-explained FIG. 1 is shown the embodiment in which the containers 1 are arranged at an equal distance in a single row in a peripheral portion of the turntable. As shown in FIGS. 2 and 3, the adaptors 8 may be arranged in double rows, if necessary.

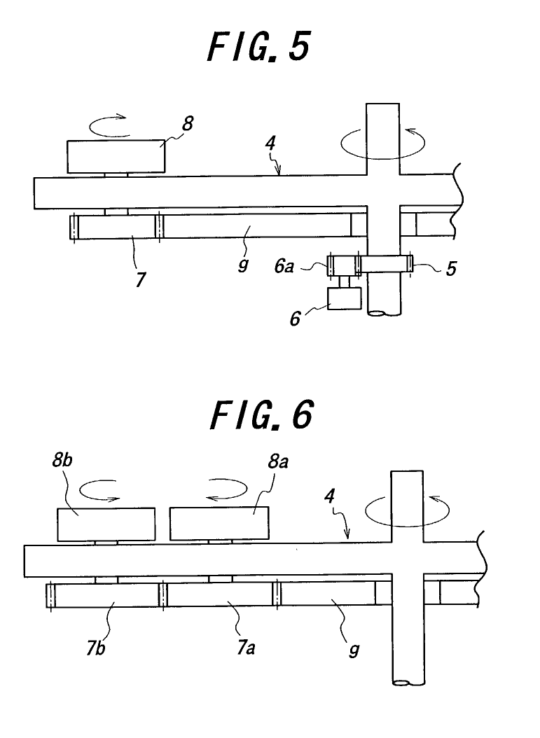

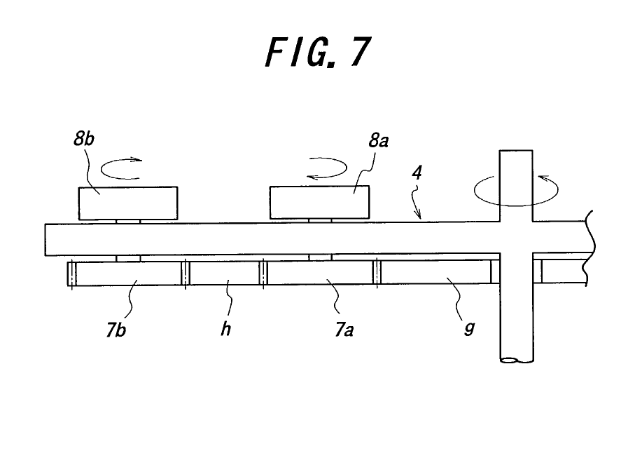

The direction in which the container 1 rotates around its own rotary axis is reverse to that in the state that the gear 2a of the base member 2 meshes directly with the rotary center-rotating gears 7a, 7b. On the other hand, when another gear is interposed between the gear 2a and the gears 7, for example, the direction of the rotation of the containers around the rotary axis L can be made in conformity with that of the rotation of the containers around their own respective rotary centers. FIGS. 5 to 7 show a type in which the rotary shaft of the turntable 4 is directly rotated by the driving source 6 such as the motor. In the figures, g is a stationary gear, and h is a gear interposed between the adaptors 8a, 8b to adjust the rotating direction thereof.

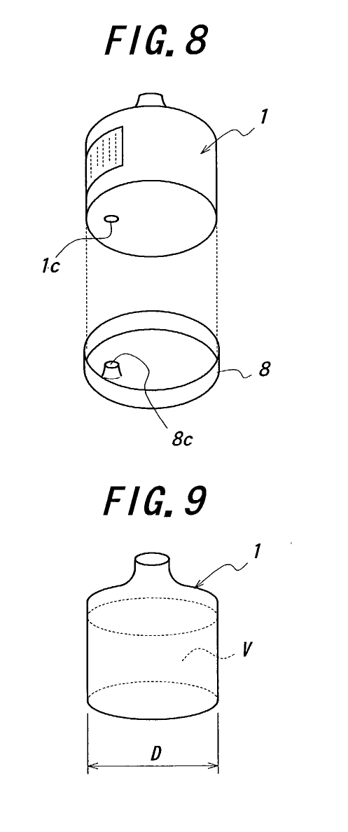

A rubbery material may be placed on a bottom face of the adaptor 8 for placing the container 1 so that the idling of the container 9 can be prevented from running idle during the rotation of the container around its own rotary center. As shown in FIG. 8, a projection 8c can be provided on the bottom of the adaptor 8 at a location deviated from its rotary center, so that the idling of the container can be prevented through engaging the projection 8c into a recess 1c formed in a bottom face of the container 1.

A reagent code (barcode label or the like) is bonded to a peripheral face of the container, and in order to make the orientation of the container always constant so that the reagent code may be automatically read with a reader (bar code reader or the like), the gear ratio between the gear 2a of the base member 2 and the gear for rotating the container 1 around its own rotary center is set times multiples. The positional alignment between the reagent code and the reader can be realized, for example, by using the projection 8a provided on the adaptor 8 as a location-aligning means, bonding the reagent code to a position where the projection 8a is present, and definitely make such an adjustment to make the projection 8c most approach a location of the reader. As the location-adjusting means, marks may be provided as location-aligning means at the container and the adaptor 8, respectively, besides the above projection 8c. Alternatively, a recess or a projection may be provided at a peripheral face of the container 1, while a projection or a recess being provided at a peripheral face of the corresponding adaptor 8 to fit the recess or the projection of the peripheral face of the container.

A reagent code may be bonded in a direction in which the location-aligning means such as the projection 8c is provided so that when the container positions at the reagent code reader, the reagent code may be always directed to the reader, thereby assuredly reading the reagent code of the container.

As the container 1 at one of the predetermined position of the turntable 4 rotates around its rotary center (full circle) and if the container 1 placed in the adaptor 8 is rotated by 4 full circles, effectively mixing effects can be obtained. At that time, the gear ratio is 1:3. The present invention is not always limited to the gear ratio of 1:3, but any optimum gear ratio is selected depending upon the size of the container and the kind of the reagent as used.

As shown in FIG. 9, a cylindrical glass bottle which is commercially available as a multipurpose product and has an outer diameter D of around 33 mm and a volume V of around 20 ml may be used as the reagent container, but the size and the volume of the container may be appropriately varied.

If the diameter D of the reagent container is as small as around 22 mm, the gear ratio is preferably 1:around 6˜8 (but integer multiples).

In the automatic analysis, the reagent is dispensed in the following manner in the case that a series of operations from mixing to the dispensing of the reagent is designed to be finished in 20 minutes per one cycle (gear ratio 1:3).

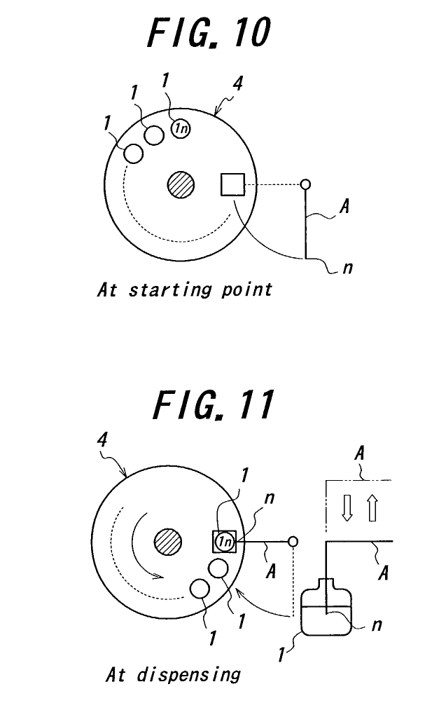

First, the turntable 4 is rotated and moved to its zero position as shown in FIG. 10. After the container 1 in which an itemized reagent necessary in the dispensing is sealed is placed on the turntable, the turntable 4 is rotated and moved to a dispensing position, and as shown in FIG. 11, a dispensing nozzle n is introduced into the container 1 to fractionate a given amount of the reagent.

In the above dispensing operation, when the reagent is dispensed after the turntable 4 makes three circuits, for example, the reagent is subjected to rotations at at least three circuits of the turntable 4 plus 12 circuits of the container around its own rotary center irrespective of the position where the reagent is set. Thereby, the particles in the reagent are dispersed and kept at a constant concentration.

Assuming that one rotation of the turntable 4 requires 1 second, the time needed for mixing is around 3 seconds. The time actually required in dispensing the reagent (including the movement of the turntable 4) is around 10 seconds. Therefore, the time required for the mixing does not afford a great effect upon the fractionating.

Mixing may be effected in the state that the direction of the rotation of the turntable 4 is the same as that of the container 1. If it is feared that the mixing efficiency decreases due to reduced frictional effect between the wall face of the container 1 and the reagent liquid, it may be that the turntable 4 is once stopped at a second turn of the totally three and then reversibly rotated (reverse rotation). By so doing, turbulent flow is formed in the reagent, so that a large mixing effect can be obtained.

When the fine particles are completely precipitated in the reagent, they can be uniformly dispersed by continuously rotating the turntable 4 at around 100 times.

The time required for this mixing is not more than 2 minutes. Considering the time required for the initializing operation of the analysis apparatus, the time required for the mixing is sufficiently short, which does not affords a great effect upon the operation of the analysis apparatus.

If the turntable 4 is continuously rotated by about 100 times in initializing the analysis apparatus and the reagent is mixed in the above manner in dispensing it, the fine particles is always uniformly dispersed in the reagent, which enables the reagent having a uniform concentration of the particles to be used in the automatic analysis.

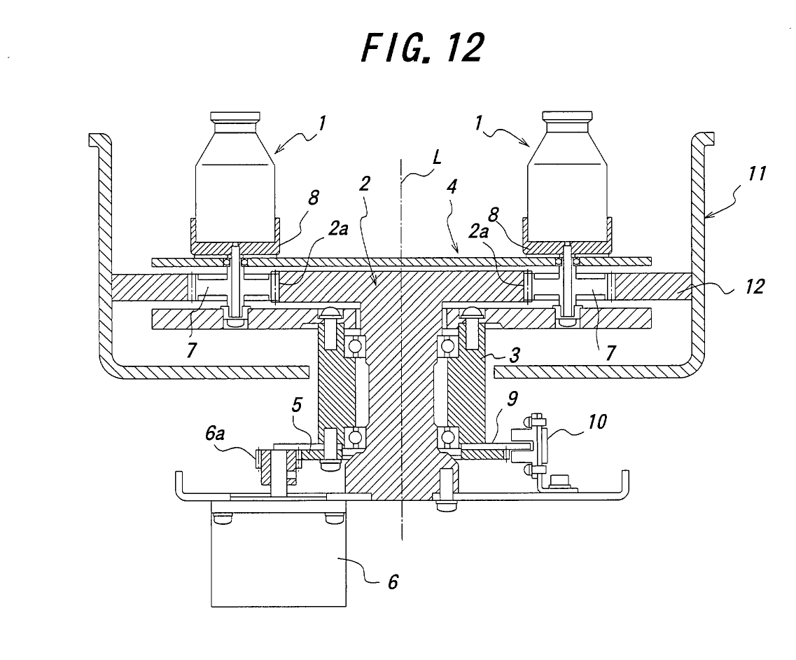

FIG. 12 shows an another embodiment of the turntable type liquid reagent-mixing device to be favorably used in the automatic analyzer which automatically analyzes the detection of the material to be measured with the fine particle-containing liquid reagent. In FIG. 12, a reference numeral 11 is a housing wall surrounding the entire turntable 4. This housing wall 11 is concentric with the base member 2, and an inner side of the housing wall is provided with an annular member 12 having a gear meshing with the rotary center-rotating gears 7.

In the thus constructed mixing device, the housing wall 11 and the annular member 12 are fixed, and as the turntable 4 is rotated by the operation of the driving source 6, the rotary center-rotating gears 7 are synchronizingly rotated along the gear of the annular member 12. Accordingly, the adaptors 8 connected with the rotary center-rotating gears are rotated, so that the containers 1 are rotated around the rotary axis L and their own respective rotary centers to mix the reagent inside the containers.

The number of rotations of the adaptors can be controlled by changing the number of teeth of the gear of the annular member, or different kinds of annular members 12 may be combined.

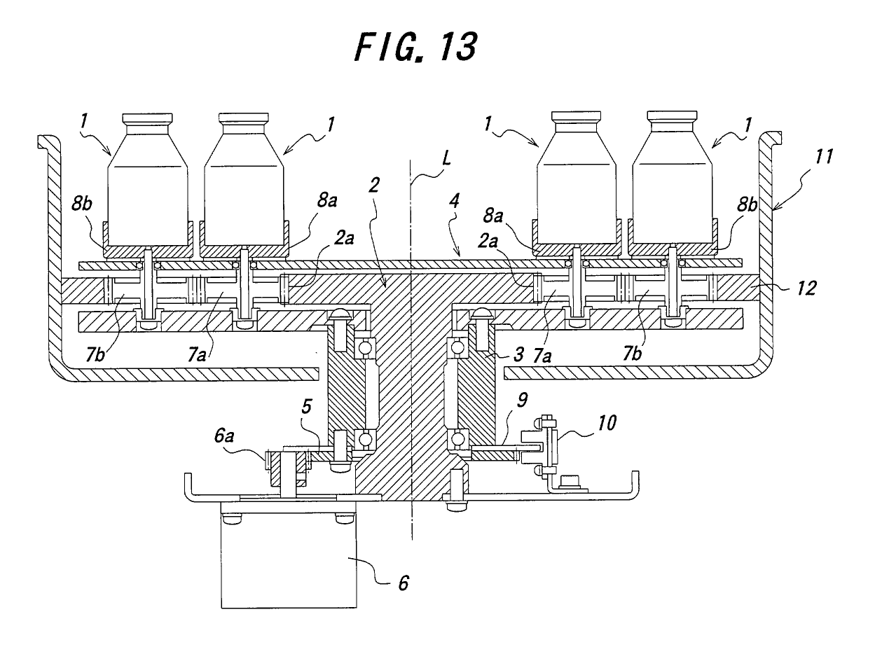

FIG. 13 shows another embodiment of the turntable type liquid reagent-mixing device shown in FIG. 12 in which the containers 1 can be arranged in double lines.

In this embodiment, a rotary center-rotating gear 7a connected with an inner adaptor 8a meshes with the gear 2a of the base member 2, and a rotary center-rotating gear 7b connected with an outer adaptor 8b meshes with an annular member 12. When the turntable 4 is rotated, the inner and outer adaptors 8a and 8b in the double lines are rotated (rotated around their own respective rotary centers).

In the above constructed mixing device, the number of rotations of the inner adaptors 8a is made equal to that of the outer adaptors 8b by appropriately changing the rotary center-rotating gears, the gear 2a of the base member 2 and the gear of the annular member 12.

The present invention can employ such a structure that slip stops of such as rubber are arranged at outer sides of the adaptors instead of the annular member 12 and the adaptors 8 contact directly with the inner wall of the housing wall 11. Thus, the invention is not limited to ones shown in the drawings, and may be varied in various ways depending upon situations.

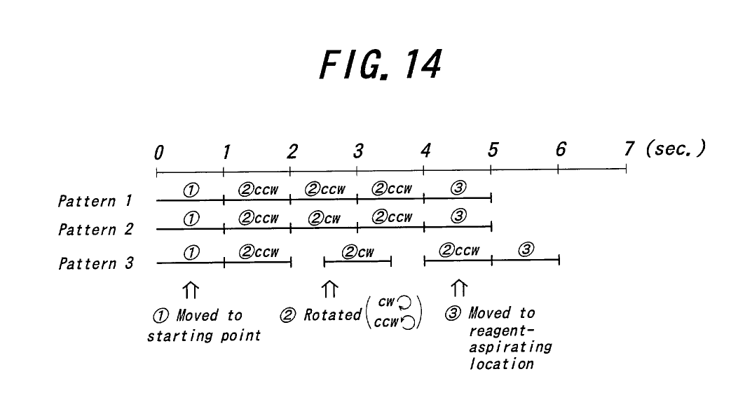

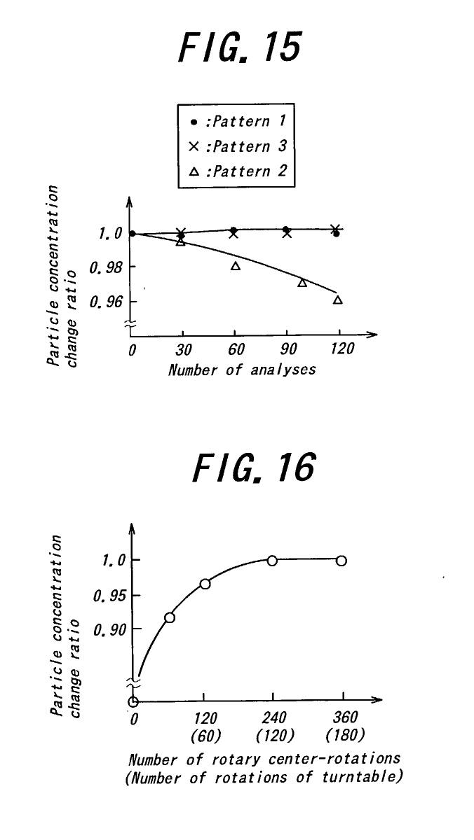

Dispersed states of particles are shown in FIG. 15 with respect to mixing cases according to three patterns (only as to the movement of the turntable) as shown in FIG. 14: a case where the container 1 in which the reagent was sealed was placed on the adaptor 8 and moved to the zero point, and the turntable 4 was continuously rotated counterclockwise for 3 minutes and the container was moved to the fractionating position, a case where the turntable was rotated including a reverse rotation, and a case where the turntable was stopped when the rotation of the turntable was reversed.

In FIG. 15, a particle concentration change ratio is a ratio of the concentration of the particles in the reagent dispensed from the liquid surface and that of the reagent having the particles uniformly dispersed. Particularly with respect to the patterns 1 and 3, the particles are almost uniformly dispersed even at the number of analyses of 120.

FIG. 16 shows the relationship between the number of the rotary center rotations of the adaptor 8 (the number of rotations of the turntable) and the particle concentration change ratio. After the number of the rotary center rotations of the adaptor 8 exceeds about 240, the particle concentration change ratio becomes 1.0.

As the reagent to be used in the present invention, blood cell reagents, gelatin particle reagents, and latex reagents used in an coagulation measurement, etc., magnetic particle carrier reagents used in the enzyme immunologic method, the chemical light emission immunologic method, the fluorescent immunologic method, the nucleic acid examination, etc. may be recited.

In the above embodiments, the cases where the cylindrical containers having almost flat and round bottom faces are used as the reaction containers are explained, but containers having any shapes may be used so long as they have cylindrical peripheral walls exhibiting the above-mentioned function and effects owing to the rotation around the rotary axis L. Further, “cylindrical” in the present invention includes not only “round” (“accurately round”) but also “polygonal” near “round”. Furthermore, the direction of the rotation of the containers around the rotary axis L may be appropriately changed, and the mixing effect can be enhanced by producing the turbulent flow in the liquid by changing the speed of that rotation.

[Effects of the Invention]

According to the present invention, since the reagent can be effectively mixed by the relatively simple structure, the fine particles contained therein can be assuredly uniformly dispersed.

According to the present invention, neither a mixing element or a mixing rod needs be inserted in mixing, which does not cause deterioration or contamination of the reagent. Thus, the invention can offer reliable data in the automatic analysis.

Since the direction of the reagent container can be definitely set at one in mixing, the reagent code attached to the reagent container can be assuredly directed to the reader. Thus, the code needs not be provided around the entire periphery of the container, and reading error of the adjacent reagent container can be avoided.

What is claimed is:

1. A turntable type liquid reagent-mixing device to be used in an automatically analyzing apparatus for the detection of a substance to be measured with using a liquid reagent containing fine particles, said mixing device comprising:
(1) a turntable to set some containers which contain liquid reagent to be mixed;
(2) a turntable rotating mechanism adapted for rotating said turntable to rotate said containers around a rotary center of the turntable; and
(3) a container-rotating mechanism for rotating the containers themselves around their own respective rotary centers at their respectively placed locations on the turntable.

2. The turntable type liquid reagent-nixing device set forth in claim 1, wherein said driving mechanism for rotating the containers around their own respective rotary centers is to be driven by the turntable-rotating mechanism, and thereby the containers themselves are rotated around their own rotary centers.

3. The turntable type liquid reagent-mixing device set forth in claim 2, wherein the turntable-rotating mechanism comprises a motor and a turntable-rotating power transmitting portion, said driving mechanism for rotating the containers around their own respective rotary centers is rotated by the turntable-rotating power transmitting portion, and thereby the containers themselves are rotated around their own rotary centers at locations of the turntable where the containers are place.

4. The turntable type liquid reagent-mixing device set forth in claim 2 or 3, wherein the turntable-rotating mechanism further comprises a first gear, the said driving mechanism for rotating the containers around their own respective rotary centers further comprises second gears, and said second gears mesh with the first gear.

5. The turntable type liquid reagent-mixing device set forth in claim 5, wherein teeth portions of the second gears mesh with an outer teeth portion of the first gear.

6. The turntable type liquid reagent-mixing device set forth in claim 5, wherein a third annular gear is arranged at an outer peripheral portion of the second gears, and an inner teeth portion of the third annular gear meshes with those of the second gears.

7. The turntable type liquid reagent-mixing device set forth in claim 2 or 3, wherein the containers rotate around their own rotary centers, respectively, by integral multiples times per one rotation around a rotary center of the turntable.

8. The turntable type liquid reagent-mixing device set forth in claim 1, wherein the driving mechanism for rotating the containers around their own respective rotary centers comprises container-placing adaptors for holding respective containers, and the containers are rotated by rotating the respective container-placing adaptors.

9. The turntable type liquid reagent-mixing device set forth in claim 8, wherein the containers comprise means of preventing the containers from running idle by the container-placing adaptors.

10. The turntable type liquid reagent-mixing device set forth in claim 1, wherein a plurality of said containers are arranged concentrically around a rotary axis of the turntable.

11. The turntable type liquid reagent-mixing device set forth in claim 9, wherein a plurality of said containers are arranged concentrically around a rotary axis of the turntable in two or more lines.

12. The turntable type liquid reagent-mixing device set forth in claim 1, wherein a code reader is provided to read liquid reagent codes attached to the containers containing the liquid reagent.

13. A turntable type liquid reagent mixing/dispensing apparatus to be used in an automatic analysis apparatus for the detection with a liquid reagent containing fine particles of a material to be measured, said mixing/dispensing apparatus comprising a turntable type liquid reagent-mixing device and a dispensing device, said turntable type liquid reagent-mixing device comprises:
(1) a turntable to set a plurality of containers which contain the liquid regent to be mixed;
(2) a turntable-rotating mechanism for rotating the turntable to rotate the containers around a rotation center of the turntable; and
(3) a driving mechanism for rotating the containers around their own respective rotary centers at places of the turntable where the containers are placed.

14. The turntable type liquid reagent mixing/dispensing apparatus set forth in claim 13, wherein said driving mechanism for rotating the containers around their own respective rotary centers is to be driven by the turntable-rotating mechanism, and thereby the containers themselves are rotated around their own rotary centers.

15. The turntable type liquid reagent mixing/dispensing apparatus set forth in claim 14, wherein the turntable-rotating mechanism comprises a motor and a turntable-rotating power transmitting portion, said driving mechanism for rotating the containers around their own respective rotary centers is rotated by the turntable-rotating power transmitting portion, and thereby the containers themselves are rotated around their own rotary centers at locations of the turntable where the containers are place.

16. The turntable type liquid reagent mixing/dispensing apparatus set forth in claim 14 or 15, wherein the turntable-rotating mechanism further comprises a first gear, the said driving mechanism for rotating the containers around their own respective rotary centers further comprises second gears, and said second gears mesh with the first gear.

17. The turntable type liquid reagent mixing/dispensing apparatus set forth in claim 16, wherein teeth portions of the second gears mesh with an outer teeth portion of the first gear.

18. The turntable type liquid reagent mixing/dispensing apparatus set forth in claim 16, wherein a third annular gear is arranged at an outer peripheral portion of the second gears, and an inner teeth portion of the third annular gear meshes with those of the second gears.

19. The turntable type liquid reagent mixing/dispensing apparatus set forth in claim 14 or 15, wherein the containers rotate around their own rotary centers, respectively, by integral multiples times per one rotation around a rotary center of the turntable.

20. The turntable type liquid reagent mixing/dispensing apparatus set forth in claim 13, wherein the driving mechanism for rotating the containers around their own respective rotary centers comprises container-placing adaptors for holding respective containers, and the containers are rotated by rotating the respective container-placing adaptors.

21. The turntable type liquid reagent mixing/dispensing apparatus set forth in claim 20, wherein the containers comprise means of preventing the containers from running idle by the container-placing adaptors.

22. The turntable type liquid reagent mixing/dispensing apparatus set forth in claim 13, wherein a plurality of said containers are arranged concentrically around a rotary axis of the turntable.

23. The turntable type liquid reagent mixing/dispensing apparatus set forth in claim 22, wherein a plurality of said containers are arranged concentrically around a rotary axis of the turntable in two or more lines.

24. The turntable type liquid reagent mixing/dispensing apparatus set forth in claim 13, wherein a code reader is provided to read liquid reagent codes attached to the containers containing the liquid reagent.

25. An automatic analyzer comprising the turntable type liquid reagent mixing/dispensing apparatus set forth in claim 13, a reactor for mixing and reacting the liquid reagent dispensed from the mixing/dispensing apparatus with a liquid to be examined, such as blood or urine, and a detector for reading out a reaction result of a reaction product obtained by the reaction.
